(19) United States
(12) Patent Application Publication
(10) Pub. No.: US 2008/0106762 A1
(43) Pub. Date: May 8, 2008

(54) Method and system for monitoring a stock of consumable material

(75) Inventors: Matthijs F. Mullender, Venlo (NL); Joost Meijer, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/979,061

(22) Filed: Oct. 30, 2007

(30) Foreign Application Priority Data
Nov. 3, 2006 (EP) 06123438.1

(51) Int. Cl. G06F 15/00

(52) U.S. Cl. 358/1.16

(57) ABSTRACT

A system for monitoring a stock of consumable material includes an image forming apparatus having an identifying unit that identifies a consumable material item inserted therein, a stock monitoring module, a counting device that derives usage data relating to consumable material in the stock and a memory. A method for monitoring a stock of consumable material in the system includes identifying a consumable material item inserted in the image forming apparatus, sending the identity of the item to the stock monitoring module, creating a distinct entry for said item in the memory upon reception for the first time by the stock monitoring module of the identity of the item and deriving usage data relating to said item.

### CROSS-REFERENCE TO RELATED APPLICATIONS

This nonprovisional application claims priority under 35 U.S.C. § 119(a) on Patent Application No. 06123438.1, filed in the European Patent Office on Nov. 3, 2006, the entirety of which is incorporated herein by reference.

### BACKGROUND OF THE INVENTION

1. Field of the Invention

The present invention relates to a method for monitoring a stock of consumable material in a system comprising an image forming apparatus. The present invention further relates to a system for monitoring a stock of consumable material, comprising an image forming apparatus, a stock monitoring module, a memory and a counting device that derives usage data relating to consumable material, the image forming apparatus, the stock monitoring module, the memory and the counting device being operationally interconnected.

2. Description of Background Art

Such a system for monitoring a stock of consumable material has, for example, been disclosed by U.S. Pat. No. 5,305,199. A plurality of image forming apparatuses is arranged in a network and at least one of the image forming apparatuses (for example, an ink jet printer) includes a stock monitoring module. The stock monitoring module is fed with information relating to the usage of each of the consumable materials (for example, recording media, such as paper sheets or toner or ink) by the plurality of image forming apparatuses. This enables the determination of the inventory levels. The stock monitoring module is initialised upon receipt of each shipment of consumable supply by providing quantity information to a microprocessor. The initializing information is stored in a non-volatile memory for each consumable material. On each image forming apparatus, a counter is provided which receives information from sensors in the image forming apparatus relating to the number of impressions or number of paper sheets cycled through the apparatus. The counter provides data from which usage information can be derived relating to the number of sheets of each size of paper, for example. On the basis of this data, sheet counts are accumulated in the non-volatile memory to provide actual usage data, which is decremented against the initial inventory amount to show the remaining inventory.

Image forming apparatuses are commonly provided with media storage units such as paper roll supports or paper trays. A given media storage unit is generally suited for receiving media of various types, for example paper sheets of different quality types or colors. It happens frequently that one wishes to print images on a recording medium of a given type available on stock but not held at this moment by any media storage unit of the image forming apparatus. In this case, very often, a recording medium item of another type has to be taken out from said image forming apparatus and has to be replaced by a recording medium item of the desired type. For example, if one wants to print on colored paper, while each media storage unit of the image forming apparatus contains solely white paper sheets, one stack of white paper sheets has to be replaced by the adequate stack of color sheets. With the known system for monitoring a stock of consumable material, the counter associated with the involved media storage unit will then provide usage data, which will be decremented from the wrong inventory amount. For example, the counter will provide usage data relating to the colored paper, while said usage data will be decremented from the inventory amount of white paper. This will lead to erroneous inventory of both the white and colored paper.

### SUMMARY OF THE INVENTION

The object of the present invention is to improve a system for monitoring a stock of consumable material of the type set forth such that monitoring a stock of consumable material is reliably executed even in the event that changes relating to the consumable material present in the image forming apparatus occur.

This object is achieved by a system wherein the image forming apparatus comprises an identifying unit that identifies a consumable material item inserted in said apparatus and a sending unit that sends the identity of said item to the stock monitoring module and wherein the counting device is adapted to derive usage data relating to said item. Even in the event that a consumable material item is exchanged in the image forming apparatus, the data that is sent to the stock monitoring module contains the identity of the consumable item. Since the counting device is adapted to derive usage data relating to the identified item, the stock monitoring module is enabled to decrement the correct usage data from the correct inventory. Indeed, the stock monitoring always receives consistent data from both the image forming apparatus and the counting device.

In one embodiment, the image forming apparatus comprises a reading device that reads identifying information encoded on the consumable material item inserted in said apparatus. The reading device may comprise one or more of the following: a radio frequency identification transceiver, an optical reading unit, a magnetic reading head, and an integrated circuit reading unit. Such a reading device renders the identification of the item very reliable, and this furthermore reduces the probability of errors in the inventory of consumable material.

In another embodiment, the image forming apparatus has a writing device that writes data on a memory area of the consumable material item, said data relating to an amount of remaining material in the item. This enables the operator to obtain information relating to the amount of material in the item, even if the item is not inserted in any image forming apparatus, by means of a portable reading device, for example.

In yet another embodiment, the system further comprises a network for enabling a client computer to submit a document to be printed to the image forming apparatus, the system comprises a sending unit that sends a signal to the client computer, said signal representing one or more of the following: availability of a consumable material in the image forming apparatus, availability of a consumable material in the stock, available amount of remaining consumable material in the image forming apparatus, available amount of consumable material in the stock. This enables an application running on the client computer to gather relevant information relating to the availability of the consumable material in the stock. This in turn enables a user of the client computer to decide whether to cancel a print job when the desired consumable is not available, and/or to modify the image processing attributes and/or print settings of the job based on the available material in order to have the print job executed.

The invention also relates to a method for monitoring a stock of consumable material in a system comprising an image forming apparatus having an identifying unit that identifies a consumable material item inserted therein, a stock monitoring module, a counting device that derives usage data relating to consumable material and a memory. The method comprises the steps of identifying a consumable material item inserted in the image forming apparatus; sending the identity of said item to the stock monitoring module; creating a distinct entry for said item in the memory upon reception for the first time by the stock monitoring module of the identity of said item and deriving usage data relating to said item. The contents of a list having entries for the identified items can thus be displayed. An operator can thus easily verify that an adequate consumable material is present in the image forming apparatus when a print job is requested by a client computer. Furthermore, the operator can check that a sufficient amount of consumable material is present in the image forming apparatus in order to execute a requested print job. When several image forming apparatuses are connected by a network, wherein each of said apparatuses comprises an identifying unit that identifies a consumable material item inserted in said apparatus and a sending unit that sends the identity of said item to the stock monitoring module, the operator can easily locate a consumable material item having an entry. If the item is inserted in a given image forming apparatus it can be taken out and inserted in another one, if so required. Alternatively, the operator may notice that a consumable material item having an entry is not present in any apparatus and that it has to be searched elsewhere in the stock. Due to the fact that the image forming apparatuses send the identity of the inserted items, while a distinct entry is created in a memory for an item which identity has been received at least once, the stock monitoring module is able to track the location of the items. It is able to indicate whether an item having an entry is located in an image forming apparatus or outside.

The invention further relates to a computer program product residing on a computer readable medium comprising instructions for causing at least one process unit to perform the steps of the method of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a network printing system;

FIG. 2 is a schematic view of an image forming apparatus;

FIG. 3 is a functional schematic of a system for monitoring a stock of consumable material according to an embodiment of the present invention;

FIG. 4 is a flowchart showing steps of a method for monitoring a stock of consumable material according to an embodiment of the present invention;

FIG. 5 shows examples of lists with entries created by the stock monitoring module in chronological order; and

FIG. 6 is a flowchart showing steps of a method for monitoring a stock of consumable material according to another embodiment of the present invention.

### DETAILED DESCRIPTION OF THE PREFERRED EMBODIMENTS

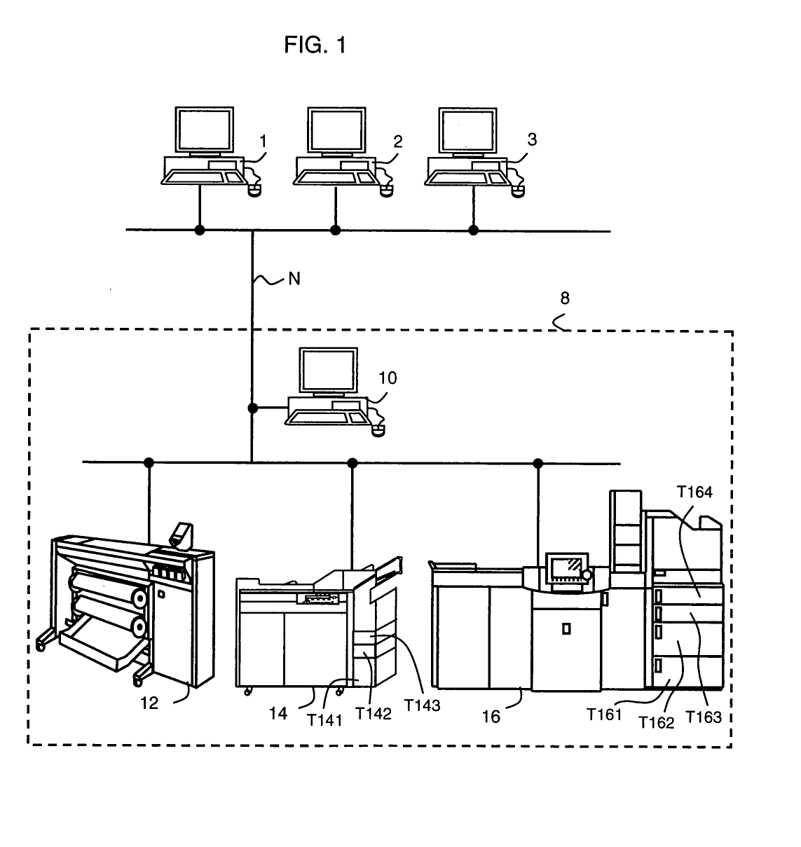

In the embodiments described hereinafter, a recording medium such as paper is given as an example of a consumable material. Consumable material refers in the present application to material consumed by an image forming apparatus when operated to print images and may also consist of ink and/or toner or the like. Referring to FIG. 1, there is shown a network printing system adapted to incorporate a system 8 for monitoring a consumable material stock according to an embodiment of the present invention. The system 8 comprises a plurality of image forming apparatuses 12, 14 and 16 for forming images on recording media such as paper. Each of the image forming apparatuses 12, 14 and 16 may be any printing apparatus capable of forming images on a recording medium, for example an ink jet printer, an electrophotographic printer, a digital copier using any printing technology, etc. For example, the image forming apparatus 12 may be a wide-format ink jet printer, the image forming apparatus 14 may be a color printer/copier and the image forming apparatus 16 may be a monochrome high-volume printing system. In this example, the printer 12 is provided with two paper roll supports, the printer 14 is provided with three input paper trays (T141, T142, T143) and the printer 16 is provided with four input paper trays (T161, T162, T163, T164). Alternately, the present invention may be embodied in a system comprising one image forming apparatus.

A consumable material stock comprises consumable material items, such as paper rolls and paper stacks, toner cartridges and ink containers that are available for use in the system 8. An item of the stock may be in place in an image forming apparatus because usage thereof is required, while another item may be in the vicinity of the image forming apparatuses or stored in a stockroom.

The system 8 provides print resources to a plurality of client workstations 1, 2 and 3 which may be remote and/or on site and which are operatively coupled through a network N (for example, a local area network or LAN) to the plurality of printers 12, 14 and 16. The system 8 further comprises a print server 10 which is also connected to the network N for enabling the client workstations 1, 2 and 3 to share the resources of the printers 12, 14 and 16. The print server 10 may comprise a plurality of queues corresponding with the printers 12, 14 and 16 and a processor for enabling the transmission of print jobs generated on the workstations 1, 2 and 3 to the printers. For example, when one of the client workstations transmits a print job to a selected one of the queues, the processor of the print server, in turn, transmits the print job to a corresponding one of the printers associated with the queue. Each queue may correspond with one or more printers.

When a user wants to print a digital document from any of the workstations 1, 2 or 3, he or she calls up a client application by clicking an icon intended for this purpose in the application window of his or her monitor. This client application, also called a job submitter, enables the user to a create and submit a print job to a printing apparatus, the user thereby assigning image processing attributes and print settings to the print job. A print job includes image data to be printed and parameters such as image processing attributes (print resolution, monochrome or color mode, image enhancement, image scaling, etc) and print settings (type of recording medium, finishing options, number of printed sets, etc). Image processing attributes and print settings are parameters used to control the printing apparatus in order to execute a print process of the print job. Once the print job is created, it is transferred through the network N to one of the queues of the print server 10. For sending the file, an https network communication may be used.

The print server 10 further comprises a stock monitoring module operationally connected with the plurality of image forming apparatuses 12, 14 and 16 for receiving usage data from the plurality of image forming apparatuses. The stock monitoring module may be implemented as a software component executed on the print server by a microprocessor.

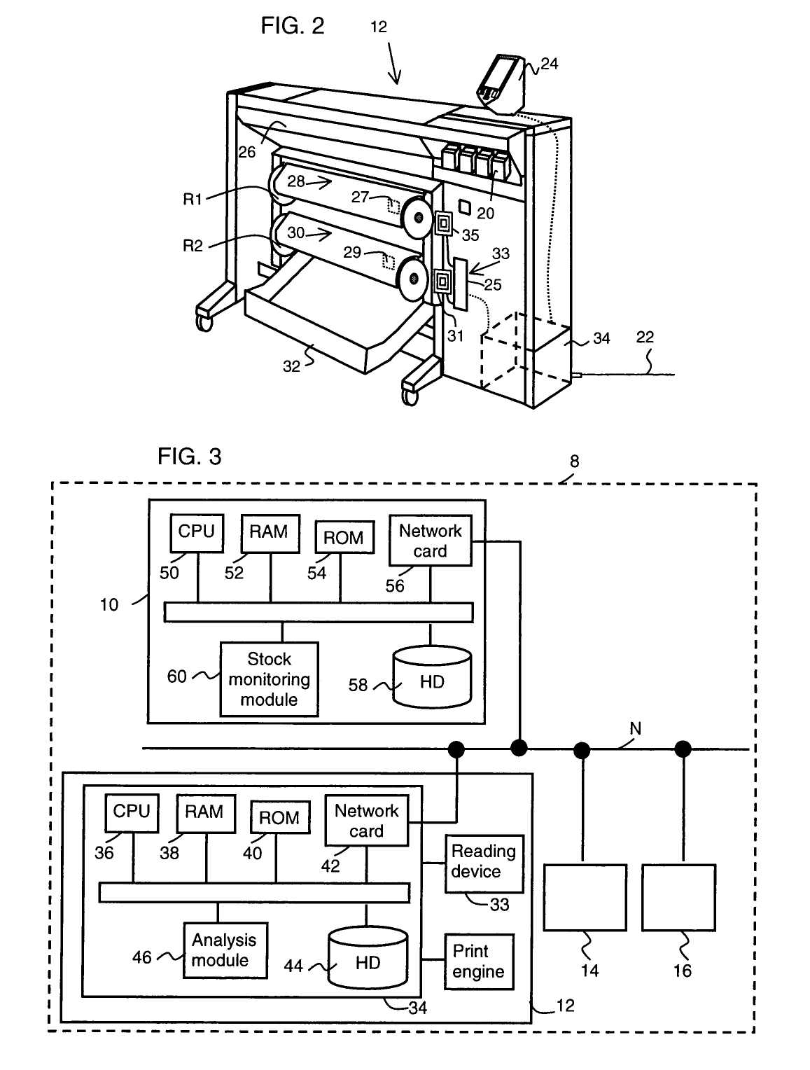

In the example of an image forming apparatus shown in FIG. 2, printing is achieved using a wide format inkjet printer 12 provided with a print engine using four different basic inks, such as cyan, magenta, yellow and black. The basic inks are stored in four ink containers 20 for supplying ink to the ink jet printhead. The images are printed on a recording medium such as paper supplied by the paper roll 28 or the paper roll 30. The paper roll 28 is supported on the paper roll support R1, while the paper roll 30 is supported on the paper roll support R2. Each one of the paper rolls 28 and 30 is an example of a consumable material item. Printed sheets of papers, cut out from the roll 28 or 30, are deposited in the delivery tray 32. The housing 26 contains the printhead (not shown) which is mounted on a carriage for printing swaths of images on paper. The local user interface unit 24 is integrated to the print engine and comprises a display unit and a control panel. The local user interface unit 24 is connected to a control unit 34 placed inside the printing apparatus 12. The control unit 34, for example a computer, comprises a processor adapted to issue commands to the print engine for controlling the print process and to perform other tasks such as described hereinafter. The connection to the network N is diagrammatically shown in the form of a cable 22, but nevertheless, the connection could be wireless.

A readable tag 27 is attached to the paper roll 28 and has identifying information stored thereon. The readable tag 27 thus stores digital data which identifies the paper roll 28. The digital data may contain, among others, a unique ID code. Similarly, a readable tag 29 which is attached to the paper roll 30, stores digital data which identifies the paper roll 30. Each of the readable tags 27 and 29 may consist of a radio frequency identification (RFID) tag (also called transponder), which is an object used for the purpose of identification using radio waves. Alternatively, each of the readable tags 27 and 29 may comprise an optical bar code, a magnetic memory chip or a smart card (i.e. an integrated circuit card).

The printing apparatus 12 comprises a reading device 33 for reading the identifying information stored on the readable tags 27 and 29 attached to each of the paper rolls 28 and 30, respectively. The reading device 33 may comprise a radio frequency identification transceiver 25 and two receiving antennas 31 and 35. The antenna 35 is placed in the vicinity of the paper roll support R1 such that it is capable of receiving the signal identifying the paper roll supported by the support R1. The antenna 31 is placed in the vicinity of the paper roll support R2 such that it is capable of receiving the signal identifying the paper roll supported by the support R2. The device 33 is thus arranged in the printer 12 such that reading identifying information stored on any of the RFID tags 27 and 29 is enabled when the rolls are inserted in the printer. Each RFID tag comprises a microchip attached to a co-operating antenna for receiving radio signals from and sending signals to the reading device 33. In this way, identifying information is transmitted to the reading device 33, which in turn transmits said identifying information to the control unit 34 for analysis purposes. Alternately, depending on the tag type used, the reading device 33 may comprise an optical reading unit able to read an optical bar code, a magnetic read head for reading data stored on a memory chip, or a reading device for reading a smart card.

The control unit 34, which is functionally represented in FIG. 3, comprises a sending unit that sends the identity of the items 28 and 30 respectively, to the stock monitoring module of the print server 10. As indicated above, the control unit 34 comprises a processor 36 (CPU) for controlling the print process carried out by the print engine and for performing other tasks. The control unit 34 further comprises a Random Access Memory 38 (RAM), a Read Only Memory 40 (ROM), a network card 42 and a hard disk 44 (HD). The aforementioned parts are interconnected through a bus system. The ROM 40 stores programs and data such as boot program, set-up program, various set-up data or the like, which are to be read out and executed by the CPU 36. The HD 44 is an example of a storage unit for storing and saving programs and data which make the CPU 36 execute its tasks. The programs and data on the HD 44 are read out onto the RAM 38 by the CPU 36 as needed. Moreover, the reading device 33 is operatively connected to the control unit 34 which is suited for controlling the operation of the reading device. The network card 42 connects the control unit 34 to the network N and is designed to provide communication with the print server 10 via the cable 22.

A device that determines usage data relating to an identified consumable material item will now be described. An analysis module 46 is provided on the control unit 34 for analyzing the identifying information that is read on the tags by the reading device 33. The analysis module 46 may be implemented as a program running on the control unit 34. The analysis module 46, upon reception of the identifying information stored on the readable tag attached to each of the paper rolls inserted in the printer 12 is also able to determine usage data relating to the recording medium of each of the paper rolls in place. It is understood that many consumable material items (paper rolls or paper stacks or the like) are present in the stock, while at most two (in the example shown in FIG. 2) paper rolls are placed at the same time in the printing apparatus 12. During operation of the printer 12, the antennas 31 and 35 of the reading device 33 send, at regular and frequent time intervals (typically, a few seconds), radio signals suited for interrogating an RFID tag of a consumable material item inserted in the printer 12. In this case, the antennas of the reading device 33 are said to be continuously or quasi-continuously active. Alternately, the antennas 31 and 35 can be activated only when needed by means of a detecting sensor. This so-called on-demand method can be triggered by optical, pressure, or other kinds of proximity sensors suited for detecting any change of consumable material item in the printer.

Upon reception of the radio signals, each one of the RFID tags of the paper rolls in place in the printer 12 sends signals to the reading device 33, which signals comprise an ID code. In the present situation, wherein paper rolls 28 and 30 are inserted, the reading device 33 will receive the unique ID codes identifying the paper rolls 28 and 30, respectively, and transmit these ID codes to the control unit 34. Based on the execution of print jobs, which are controlled by the CPU of the control unit 34, the analysis module 46 is able to associate a paper usage (for example, in meters) to a paper roll identified by its ID code. For example, when the printer 12 executes various print jobs, the analysis module associates a paper usage of X meters to the ID code of the paper roll 28 and a paper usage of Y meters to the ID code of the paper roll 30. In the event that one of the paper rolls 28 or 30 is removed and replaced by a third paper roll (not shown), the RFID tag of this third paper roll will send identifying information enabling the analysis module to furthermore associate a paper usage Z to said third roll.

Once the usage data is determined (for example, X meters for the paper roll 28, Y meters for the paper roll 30, and possibly Z meters for the third roll), which data may be stored on the HD of the control unit 34, the CPU 36, in co-operation with the network card 42 ensures that the identity and the usage data relating to each of the identified consumable material items is sent to stock monitoring module. As indicated above, the print server 10 comprises a stock monitoring module operationally connected with the plurality of image forming apparatuses 12, 14 and 16 for receiving identifying information and usage data from the plurality of image forming apparatuses.

The print server 10 may be a PC having a processor 50 (CPU), a Random Access Memory 52 (RAM), a Read Only Memory 54 (ROM), a network card 56 and a hard disk 58 (HD). The HD 58 is suited for storing and saving programs and data which make the CPU 50 execute its tasks. The network card 56 connects the print server 10 to the network N and is designed to provide communication with the client workstations 1, 2 and 3, and with the printing apparatuses 12, 14 and 16. The stock monitoring module 60 may be a program running on the print server 10. Upon reception of the identity and usage data, the stock monitoring module 60 is capable of determining of an up-to-date state of consumable material in the stock. In the event that it is the first time that the print server 10 receives identifying information relating to the paper roll 28, the stock monitoring module 60, based on the ID code of the roll 28, creates a distinct entry for the roll 28 in a list stored in the memory, for example on the HD 58. Based on the ID code, and using a database stored elsewhere on the HD 58, the stock monitoring module 60 may be able to recognize the type of recording medium item that the roll paper 28 has. An initial quantity of recording medium, which may be available from the database as well, is associated by the stock monitoring module 60 to the roll paper 28. To obtain the up-to-date quantity of paper, the usage data (in this case, X meters) is simply subtracted from the initial quantity of recording medium. On the other hand, if information identifying the paper roll 28 had already been sent in the past to the print server 10 by any image forming apparatus belonging to the system 8, the list stored on the HD 58 already contains a distinct entry for the roll 28. Then, the usage data (X meters) is subtracted from a previously determined quantity of paper available in the roll 28. The same procedure applies to any identifying information and usage data received by the print server 10. It should be noted that the identifying information and usage data is transmitted at regular intervals to the print server 10, which enables the determination of an almost continuously updated state of the consumable material in the stock. Of course, if no print job is executed between the intervals, the usage data is simply zero, and the quantity of available recording medium in an identified recording medium item, as determined by the stock monitoring module 60, remains constant. The contents of the list stored on the HD 58 (i.e. the identities of the items, the location thereof and the remaining amount of consumable material in each item) may be displayed on a monitor of the print server 10.

Alternately, the RFID tag of a paper roll may store more information than just an ID code. It may store data relating to the type of recording medium and to an initial quantity of recording medium, which data may be transmitted together with the ID code to the stock monitoring module 60.

Alternately, the image forming apparatus sends only the identity of the item(s) inserted in said apparatus. The print server 10, which manages the print jobs, is able to determine usage data related to the consumed material of the item, based on the parameters of the print jobs. The determination of the usage data may be based on the format of the document to be printed, which may be indicated in a job ticket or in the document data transmitted for printing purposes.

The RFID tags may be of the type “read-only,” meaning that they are programmed during their manufacturing process and cannot be altered. Such “read only” RFID tags are inexpensive and well suited for basic identification requirements. Alternately, the RFID tags may be of the type “read-write,” indicating that they possess memory types and operational architectures that allow the memory contents to be written to as well as read from by the device 33 or written to by a distinct writing device. In another embodiment, wherein each RFID tag is of the type “read-write,” the remaining amount of recording material is written onto a writable memory area (for example an EEPROM) of the RFID tag while the recording medium item is in the printing apparatus. In this case, the usage data sent to the stock monitoring module is simply the quantity of remaining recording medium in the identified item. The operator, by means of a separate portable reading device, may thus easily obtain quantity information and identity of a consumable material item, even if the operator is far from the print server 10 and does not see the monitor displaying the contents of the list.

In yet another embodiment, the stock monitoring module is installed on any of the printing apparatuses instead of on the print server. The stock monitoring module may be mirrored by any number of other printing apparatuses belong to the system 8.

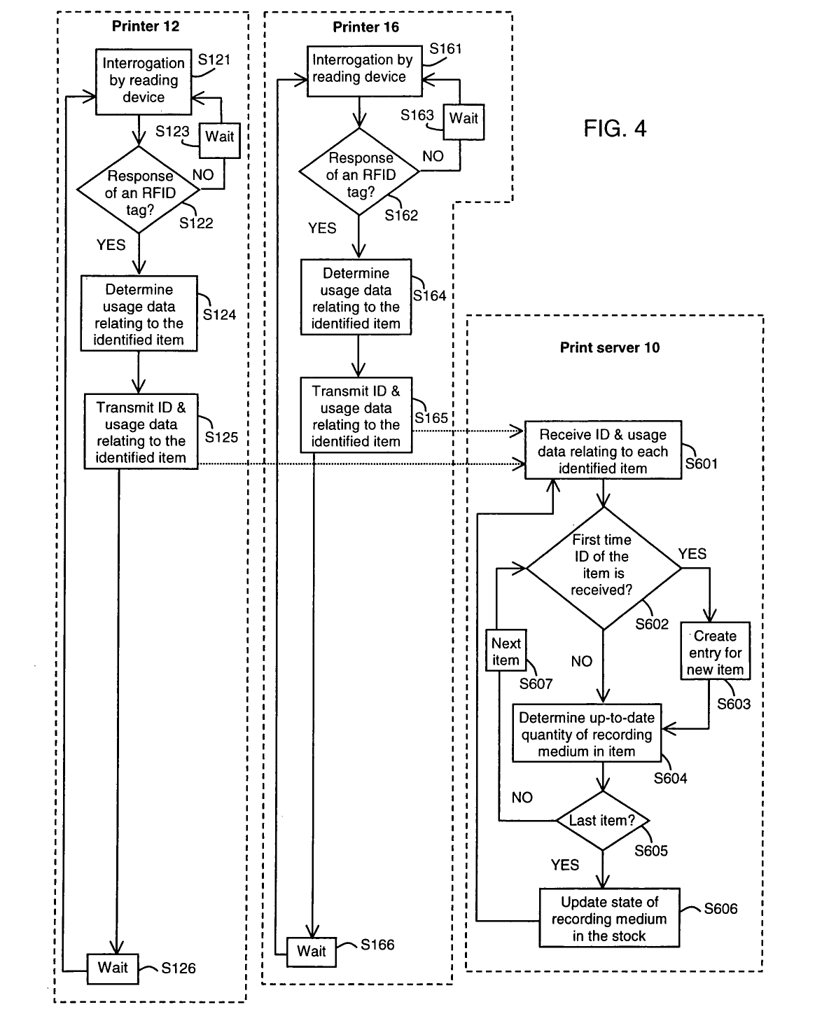

The method for monitoring a recording medium stock according to an embodiment of the present invention is illustrated by the flow chart in FIG. 4. For the sake of simplicity, only the processes occurring at the printing apparatus 12 and 16 and at the print server 10 are shown. However, any number of print apparatuses could be involved. The method may be implemented in a network printing system such as shown in FIG. 1 and the steps of the method may be executed by computer programs running on the different apparatuses. In step S121, the reading device 33, controlled by the control unit 34, interrogates the RFID tags of paper rolls that may be inserted in the printer 12. In step S161, which does not necessarily occurs simultaneously with step S121, the reading device of the printer 16 interrogates the RFID tags of paper stacks that may be in the paper input trays of the printer 16. A paper stack is an example of a consumable material item, whereby the RFID tag may be glued on the last page of the stack, or be integrated in a packaging, provided it remains together with the paper stack when used by the printing apparatus.

In the event that paper rolls are present in the printer 12, their associated RFID tags will send signals to the reading device 33, which in turns transmits the responses to the control unit 34. In step S122, it is checked by the control unit whether RFID tags have reacted. In the negative, the process is paused a few seconds in step S123 and then, step S121 is executed again. In the event that the control unit 34 receives a positive signal in S122, indicating that at least one consumable material item has been detected in the printer 12, the program proceeds to step S124 wherein usage data relating to each identified item is determined. For example, the analysis unit 46 checks whether print jobs have been executed since the last check. Since the control unit is also suited for processing print jobs submitted by a client workstation, the analysis module 46 is able to determine the amount of paper that has been used to execute said print jobs. This enables the analysis module to associate a usage data to each of the identified rolls, for example in the form of a consumed paper length.

Similar processes (steps S162, S163 and S164) are executed by the control unit of the printing apparatus 16. Since this apparatus uses cut sheets, the analysis module of the control unit associates usage data to each of the identified paper stacks, for example in the form of a number of consumed sheets.

In steps S125 and S165, the ID code and usage data relating to each identified item are transmitted to the print server 10, using the network N, for example. In step S601, the ID code and the usage data relating to each of the identified recording medium item are received by the print server 10. In step S602, the stock monitoring module 60 checks whether the ID code of an item is sent for the first time. To perform this task, the stock monitoring module 60 simply compares the ID code of the item with the ID codes already received, each of said ID code having a distinct entry in the list. When an item is identified for the first time, a new and distinct entry is created in the list (S603). For the item, the stock monitoring module determines an up-to-date quantity of recording medium in the item in step S604. This is simply done by subtracting the usage data from an initial amount of consumable material of the item or from a previously determined amount of consumable material in the item. If it was the first time that the ID of the item was received, this indicates that the item contains an initial amount of recording medium. The initial amount of recording medium may be found in a database stored on the print server, able to associate an initial amount of consumable material in an item, based on its ID code. Alternately, the initial amount of recording medium in an item may be stored on the thereto attached RFID, and transmitted together with the ID code. For each one of the identified items of which the ID code was received in S601, an up-to-date quantity of recording medium in the item is determined, by means of a loop executed in steps S605 and 607. When this has been done for all identified items, finally, the stock monitoring module 60 outputs in step S606 an updated state of recording medium in the stock. In the list, the relevant quantity of remaining recording medium is associated to each item identified by means of its ID code. The list may be displayed on the monitor of the print server 10, in order to inform an operator of the up-to-date state of recording medium in the stock.

In steps S126 and S166, the programs running on the respective control units of the printing apparatuses 12 and 16 may pause a few seconds, after what interrogation of the RFID tags by the reading devices starts again (S121 and S161).

The steps of the method illustrated in FIG. 4 are executed according to a loop during the whole period that the system 8 is operated, typically, during a whole working day. When, for example, a given paper stack is taken out from the printer 14 (together with its RFID tag), put aside a few moments, and then inserted in a tray of the printer 16, the stock monitoring module of the system will still operate correctly and will be able to determine an up-to-date state of consumable material in the stock. Since each printer comprises a reading device for reading identifying information stored on a readable tag attached to each consumable material item inserted in the printer, and a sending unit that sends the identity relating to the item to the stock monitoring module, no manual entry at the print apparatus is required in order to inform a printing apparatus or the stock monitoring module of any consumable material item change.

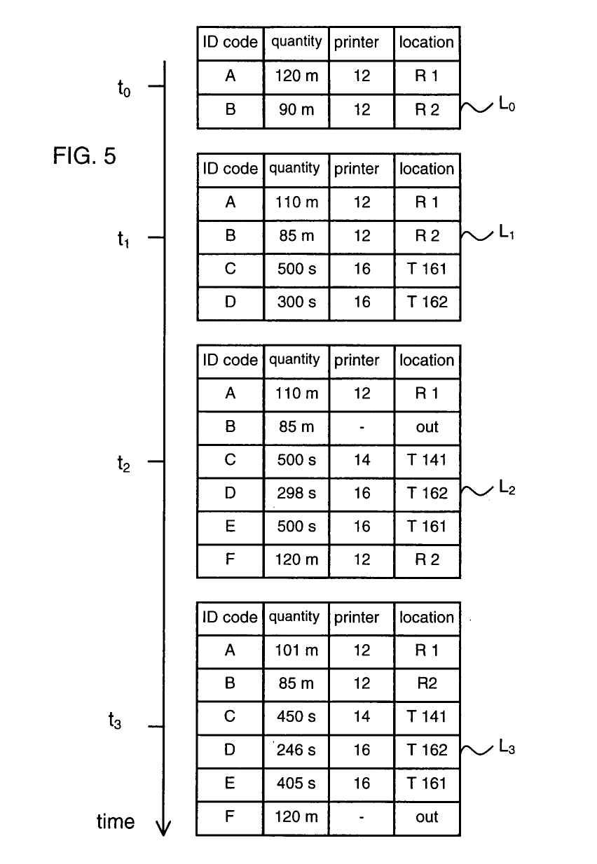

FIG. 5 exemplifies the contents of the list stored on the HD 58, which tracks the location and quantity of remaining consumable material in each item having been identified at least once and thus having a distinct entry. Initially, i.e. before the moment t₀, the system does not comprise any recording medium item. Then, the printing apparatus 12 is filled with a first and a second paper roll, having respectively the ID codes “A” and “B,” stored on their respective RFID tags. The steps illustrated in FIG. 4 being carried out in a loop, at a certain moment, the ID codes “A” and “B” are sent to the stock monitoring module 60 (S125). No printing job is executed yet and the usage data is thus zero. It is the first time that the ID codes “A” and “B” are received by the stock monitoring module 60. Therefore, at time t₀, the stock monitoring module creates two entries in the list L₀ (in step 603). After step S606, the contents of the list L₀ may be displayed on a monitor. As seen in FIG. 5, the list L₀ associates to the paper roll having the ID code “A” an initial paper length of 120 meters and a location R1 (i.e. the roll support R1) in the printer 12. Similarly, the list L₀ associates to the paper roll having the ID code “B” an initial paper length of 90 meters and a location R2 (i.e. the roll support R2) in the printer 12.

After t₀, print jobs are executed and paper is consumed from the rolls “A” and “B.” Moreover, the first and second input paper receiving trays (T161 and T162) of the printer 16 are filled with a first and a second paper stack, having respectively the ID codes “C” and “D.” Then, the stock monitoring modules thus receives the ID codes “A,” “B,” “C” and “D” from the printers. Since the ID codes “C” and “D” are received for the first time, two distinct entries are created in the list stored on the HD 58. Then, at the moment t₁, the stock monitoring module updates the state of consumable material in the stock and outputs a list L₁ (in step 606) shown in FIG. 5. The list L₁ associates quantities equal to the respective initial quantity minus the respective usage data to the paper rolls “A” and “B.” Moreover, the list L₁ associates to the paper stack “C” an initial number of 500 sheets and the location corresponding to the first input tray T161 in the printer 16. Similarly, the list L₁ associates to the paper stack “D” an initial number of 300 sheets and the location corresponding to the second input tray T162 in the printer 16.

After t₁, the roll “B” is replaced by the roll “F” in the printer 12. The paper stack “C” is removed from the printer 16 and is put into the first receiving tray T141 of the printer 14. Paper is consumed out of the stack “D.” The paper stack “E” is put into the printer 16 at the position left vacant (T161) by the stack “C.” All of these events are tracked by the stock monitoring module, which outputs the list L₂ at a moment in time t₂ (in step 606). It is to be noted that the roll “B” is not positioned in any apparatus, and therefore, its RFID tag does not respond. However, the stock monitoring module 60 keeps information related to the roll “B” for the future.

After t₂, paper is consumed from the roll “A,” the roll “F” is replaced by the roll “B” in the printer 12, sheets are consumed from the stack “C” in the printer 14, and sheets are consumed from the stacks “D” and “E” in the printer 16. The up-to-date state of recording medium in the stock at the moment t₃ corresponds to the contents of the list L₃.

The up-to-date state of recording medium in the stock kept by the stock monitoring module 60 enables the printer server 10 to give an accurate indication on the availability of the consumable material to the users of the client workstations 1, 2 and 3, through the network N. The users are thus enabled to choose a recording medium type to create or modify their print job based on the up-to-date state of consumable material in the stock. This can be done through the job submitter of the client workstations. Once the print job is submitted, the user can be notified whether the recording medium type he/she has chosen is present in any suitable printing apparatus. In the event that the chosen recording medium is not present, the user can be proposed another medium type for immediate printing, or be notified that the chosen recording medium is present in the stock, but not placed in any printing apparatus at this very moment. In this case, the printer server 10 could notify an operator that a recording medium item has to be put in an adequate printing apparatus.

The system for monitoring a recording medium stock is also suited for charging the user of the printing apparatuses, based on the usage data sent to the print server 10, by associating a user ID to the usage data.

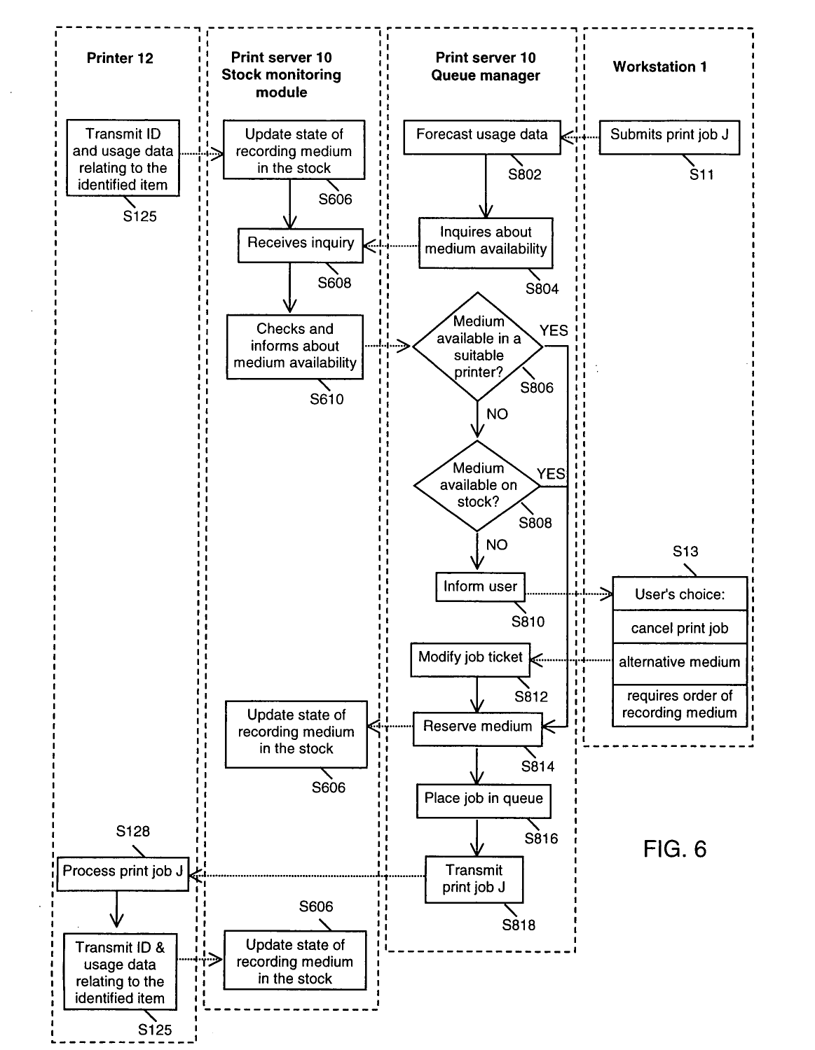

FIG. 6 is a flowchart showing steps of a method for monitoring a stock of consumable material according to another embodiment of the present invention. The processes occurring on the printing apparatus 12, on the stock monitoring module of the print server 10, on the queue manager of the print server 10 and on the workstation 1 are represented. The steps S125, wherein the image forming apparatus 12 transmits the ID code and usage data of a consumable item inserted in the apparatus 12 and S606, wherein the stock monitoring module on the printer 10 updates the state of recording medium in the stock are the same as elucidated above in conjunction with FIG. 4. Other steps required to arrive at the steps S125 and S606 are omitted in the present discussion. In particular, when the stock monitoring module 60 receives the ID of an item for the first time, an entry is created in the list stored on the HD 58 in step S603.

In step S11, a print job J is submitted by the job submitter of the workstation 1 to the queue manager of the print server 10. The job submitter, which is an application installed on the workstation, creates a so-called job ticket which describes the print settings and print job attributes chosen by the user. In particular, the job ticket contains a description of the recording medium type chosen by the user. In step S11, the document to be printed is transmitted together with the corresponding job ticket to the queue manager of the print server 10. The queue manager, based on the document properties, assigns the printer 12 for the print job J. Alternately, the user may choose the printer on which the print job J should be executed. In step S802, a sub-module of the queue manager uses the data transmitted in step S11 to forecast the material usage data for the print job J. In the present example, the forecast can be expressed in the form of a recording medium length. The forecast may be based on the document properties, for example, a format A0. The job ticket contains a specification of the recording medium type chosen by the user.

In step S804, the queue manager sends an inquiry to the stock monitoring module relating to the availability of the forecasted usage of the chosen recording medium. In step 608, the stock monitoring module receives the inquiry. In step S610, the stock monitoring module checks the availability of the recording medium type, simply by examining the list (for example, the list L₃ shown in FIG. 5) representing the up-to-date state of recording medium in the stock. The stock monitoring module may check in a database the type of recording medium carried by an identified recording medium item in the list. The stock monitoring module searches whether there is a match between the desired medium type and the types of recording medium carried by the items having an entry in the list. If there is a match, the stock monitoring module is able to determine the amount of recording medium in the item having the desired type. Then, the inventory system informs the queue manager about its findings. In step S806, based on the response sent by the stock monitoring module, it is checked whether the chosen recording medium is available in sufficient amount in a suitable printer, i.e. in this example, in the printer 12. In the positive case, the step S814 is carried out, in which the queue manager sends a request to the stock monitoring module in order to reserve the required quantity of recording medium. In step S606, the stock monitoring module reserves the required quantity of recording medium. To perform this task, the stock monitoring module updates the state of reserved recording medium for an appropriate entry in the list. This entry corresponds to the ID of the recording medium item that it to be used by the printer 12 to execute the job. From a practical point of view, this means that the reserved quantity of recording medium will not be available for other print jobs.

If the result of the test performed in step S806 is negative, a next check is performed in step S808 to find out whether the chosen recording medium is available in stock. The medium is available in stock in the case that one of the entries of the list (for example, the list L₃) is the ID of an item carrying the recording medium of the chosen type. If the recording medium is available in stock, the program goes to step S814, already described. A signal may be sent to the operator of the printing apparatus to prepare to remove the proper recording medium item from its location, which could be another printing apparatus of the system 8. If the proper item has an entry but is not inserted in any printing apparatus, the operator can locate it easily by using a portable reading device in order to read the tags of the items in the vicinity of the printers or in a stockroom. If the result of the test performed in step S808 is negative, i.e. the chosen recording medium is not available in the stock, the user is informed in step S810. In step S13, the user is invited by the job submitter to choose between the following options: cancel the print job, choose an alternative medium present in the stock, or requires the order of the chosen recording medium. According to the user's choice for an alternative medium, in step S812, the job ticket may be modified. Next, the recording medium is reserved in steps S814 and S606. After that, the job is placed in the queue in step S816, and when it reaches the top of the queue, it transmitted in step S818 to the printer 12. In step S128, the print job is executed by the printing apparatus 12, which transmits to the stock monitoring module the ID and the usage data relating to the recording medium item which has been thereby consumed. This enables the stock monitoring module, in step S606 to update the state of the recording medium in the stock. In said step, the reservation that had been performed for the recording medium can be released.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for monitoring a stock of consumable material in a system comprising an image forming apparatus having an identifying unit that identifies a consumable material item inserted therein, said item having an identity code encoded thereon, a stock monitoring module, a counting device that derives usage data relating to consumable material and a memory, said method comprising the steps of:
identifying a consumable material item inserted in the image forming apparatus upon identifying the identity code encoded on said consumable material item;
sending the identity code of said consumable material item to the stock monitoring module;
creating a distinct entry for said consumable material item in the memory upon reception for the first time by the stock monitoring module of the identity code of said consumable material item; and
deriving usage data relating to said consumable material item.

2. The method according to claim 1, further comprising the step of associating one or more of the following to each distinct entry existing in the memory:
availability in the image forming apparatus of a consumable material item having an entry;
available quantity of consumable material in the consumable material item having an entry; and
location of the consumable material item having an entry.

3. The method according to claim 1, wherein the image forming image apparatus has a writing device, said method further comprising the step of writing data on a memory area of the consumable material item, said data representing an amount of remaining material in the consumable material item.

4. The method according to claim 2, wherein the image forming image apparatus has a writing device, said method further comprising the step of writing data on a memory area of the consumable material item, said data representing an amount of remaining material in the consumable material item.

5. The method according to claim 1, wherein the system comprises a network for enabling a client computer to submit a document to be printed to the image forming apparatus, said method further comprising the step of sending a signal to the client computer, said signal representing one or more of the following:
availability of a consumable material in the image forming apparatus;
availability of a consumable material in the stock;
available amount of consumable material in the image forming apparatus; and
available amount of consumable material in the stock.

6. The method according to claim 2, wherein the system comprises a network for enabling a client computer to submit a document to be printed to the image forming apparatus, said method further comprising the step of sending a signal to the client computer, said signal representing one or more of the following:
availability of a consumable material in the image forming apparatus;
availability of a consumable material in the stock;
available amount of consumable material in the image forming apparatus; and
available amount of consumable material in the stock.

7. The method according to claim 5, further comprising the step of presenting an alternative choice of printing parameters to a user of the client computer for printing the document to be printed if a chosen consumable material is not available.

8. The method according to claim 6, further comprising the step of presenting an alternative choice of printing parameters to a user of the client computer for printing the document to be printed if a chosen consumable material is not available.

9. The method according to claim 1, wherein the system comprises a network for enabling a client computer to submit a document to be printed to the image forming apparatus, said method further comprising the step of charging an account, based on the usage data relating to said consumable material item.

10. A system for monitoring a stock of consumable material, comprising:
a stock monitoring module;
an image forming apparatus, the image forming apparatus comprising:
an identifying unit that identifies a consumable material item inserted in said image forming apparatus, said consumable material item having an identity code encoded thereon; and
a sending unit that sends the identity code of said consumable material item to the stock monitoring module;
a memory; and
a counting device that, the counting device being adapted to derive usage data relating to said consumable material item, said consumable material item having a distinct entry in the memory,
wherein the image forming apparatus, the stock monitoring module, the memory and the counting device are operationally interconnected.

11. The system according to claim 10, wherein the image forming apparatus comprises a reading device that reads identifying information encoded on the consumable material item inserted in said image forming apparatus.

12. The system according to claim 11, wherein the reading device comprises one or more of the following:
a radio frequency identification transceiver;
an optical reading unit;
a magnetic reading head; and
an integrated circuit reading unit.

13. The system according to claim 10, wherein the image forming apparatus has a writing device that writes data on a memory area of the consumable material item, said data relating to an amount of remaining material in the consumable material item.

14. The system according to claim 11, wherein the image forming apparatus has a writing device that writes data on a memory area of the consumable material item, said data relating to an amount of remaining material in the consumable material item.

15. The system according to claim 10, further comprising a network for enabling a client computer to submit a document to be printed to the image forming apparatus,
wherein the system is adapted to send a signal to the client computer, said signal representing one or more of the following:
availability of a consumable material in the image forming apparatus;
availability of a consumable material in the stock;
available amount of remaining consumable material in the image forming apparatus; and
available amount of consumable material in the stock.

16. The system according to claim 11, further comprising a network for enabling a client computer to submit a document to be printed to the image forming apparatus,
wherein the system is adapted to send a signal to the client computer, said signal representing one or more of the following:
availability of a consumable material in the image forming apparatus;
availability of a consumable material in the stock;
available amount of remaining consumable material in the image forming apparatus; and
available amount of consumable material in the stock.

17. A computer program product residing on a computer readable medium comprising instructions for causing at least one process unit to perform a method for monitoring a stock of consumable material in a system comprising an image forming apparatus having an identifying unit that identifies a consumable material item inserted therein, said item having an identity code encoded thereon, a stock monitoring module, a counting device that derives usage data relating to consumable material and a memory, said method comprising the steps of:
identifying a consumable material item inserted in the image forming apparatus upon identifying the identity code encoded on said consumable material item;
sending the identity code of said consumable material item to the stock monitoring module;
creating a distinct entry for said consumable material item in the memory upon reception for the first time by the stock monitoring module of the identity code of said consumable material item; and
deriving usage data relating to said consumable material item.
